(19) United States
(12) Patent Application Publication
(10) Pub. No.: US 2017/0168303 A1
(43) Pub. Date: Jun. 15, 2017

(54) Head-Mounted Display Systems with Nose Piece

(71) Applicant: Facebook, Inc., Menlo Park, CA (US)

(72) Inventor: Yury Anatolievich Petrov, Half Moon Bay, CA (US)

(21) Appl. No.: 14/964,476

(22) Filed: Dec. 9, 2015

(51) Int. Cl. G02B 27/01; G02B 5/00; G02C 11/08

(52) U.S. Cl. CPC G02B 27/0176; G02C 11/08; G02B 5/003; G02B 2027/0156

(57) ABSTRACT

A head-mounted display (HMD) system includes a display and a headset, containing the display, to mount on a user's face. The HMD system further includes a nose piece coupled to the headset. The nose piece includes a check valve to allow a uni-directional out-flow of air from inside the nose piece.

### TECHNICAL FIELD

This application relates generally to gaming entertainment and virtual-reality systems, and more specifically to head-mounted display systems having a headset with a nose piece so as to reduce light leakage into the headset while improving ventilation in the headset.

### BACKGROUND

Virtual-reality head-mounted displays have wide applications in various fields, including engineering design, medical surgery practice, military simulated practice, and video gaming. For example, a user wears a virtual-reality head-mounted display system integrated with audio headphones while playing video games so that the user can have an interactive experience in an immersive virtual environment.

Current HMD systems tend to allow light to leak in where the HMD curves to accommodate the nose. Also, depending on the virtual reality gaming experience, the user may have to perform various physical activities such as jumping, swinging a bat or tennis racquet, punching, or dancing. Such physical activities are physically taxing on a user and may elevate the user's body temperature and cause the user to perspire. As a result, current virtual reality and gaming HMD systems fail to simultaneously provide a light-tight HMD with sufficient ventilation for a user, who may experience elevated body temperatures during the virtual reality gaming experience. Increased temperatures inside the HMD may lead to fogging of the lenses, which may negatively affect the user's experience.

### SUMMARY

Accordingly, there is a need for HMD systems capable of limiting external light from entering into the display while providing ventilation to the lenses and user's face to prevent fogging during the gaming entertainment and virtual-reality experiences.

In accordance with some embodiments, a head-mounted display system includes a display and a headset, containing the display, to mount on a user's face and a nose piece coupled to the headset. The nose piece includes a check valve to allow a uni-directional out-flow of air from inside the nose piece.

In some embodiments, the display includes a left lens for the user's left eye and a right lens for the user's right eye. The head-mounted display system further includes a plurality of apertures positioned above the left and right lenses to introduce air to provide ventilation to the lenses and the user's face.

In some embodiments, the display includes a left display screen and a right display screen, a left eye cup coupled between the left lens and the left display screen, and a right eye cup coupled between the right lens and the right display screen.

In some embodiments, the head-mounted display system further includes a plurality of apertures positioned on an upper portion of the headset. Respective apertures of the plurality of apertures include respective S-shaped ducts to channel air into an area between the display and the user's face when the user breathes in, while blocking light from entering the headset.

In some embodiments, the nose piece is integrally formed with the headset.

In some embodiments, the nose piece is detachably coupled to the headset and includes at least one connector to couple to the headset.

In some embodiments, an outer periphery of the nose piece is contoured to accommodate a range of noses while restricting light from leaking into the headset.

In some embodiments, the check valve of the noise piece is positioned below nostrils of the user when the headset is mounted on the user's face, to selectively allow the out-flow of the air from inside the nose piece while preventing air outside of the nose piece from entering in through the nose piece.

In some embodiments, the check valve is selected from the group consisting of a ball check valve, a lift check valve, a wafer check valve, and a flap check valve.

In some embodiments, the check valve is spring-loaded to keep the check valve in a closed position.

In some embodiments, the nose piece comprises an opaque plastic material.

In some embodiments, the nose piece comprises a rubber or neoprene material.

In some embodiments, the nose piece comprises a rigid foam material.

In some embodiments, the nose piece further includes a smell injector to dispense a fluid to be inhaled by the user to stimulate olfactory senses.

In some embodiments, the headset includes a surface contoured to accommodate facial features of the user.

In some embodiments, the surface includes a porous foam material to absorb perspiration of the user.

In some embodiments, the surface includes a material selected from the group consisting of an opaque plastic, rubber, rigid foam and neoprene.

In accordance with some embodiments, a head-mounted display system includes a display including a left lens for the user's left eye and a right lens for the user's right eye, and a headset, containing the display, to mount on a user's face. The head-mounted display system further includes a plurality of apertures positioned on an upper portion of the headset. Each aperture of the plurality of apertures comprises an S-shaped duct to channel air into an area between the display and the user's face when the user breathes in, and to block light from entering the headset. The head-mounted display system additionally includes a nose piece integrally formed with the headset. The nose piece includes a check valve housed therein to allow a uni-directional out-flow of air from inside the nose piece. The check valve is positioned below nostrils of the user when the headset is mounted on the user's face, to selectively allow the out-flow of the air from inside the nose piece while preventing air outside of the nose piece from entering in through the nose piece.

In some embodiments, an outer periphery of the nose piece is contoured to accommodate a range of noses while restricting light from leaking into the headset.

In some embodiments, the plurality of apertures is positioned above the left and right lenses.

Various advantages of the present application are apparent in light of the descriptions below.

### BRIEF DESCRIPTION OF THE DRAWINGS

For a better understanding of the various described embodiments, reference should be made to the Detailed Description below, in conjunction with the following drawings. Like reference numerals refer to corresponding parts throughout the figures and description.

FIG. 1 illustrates a perspective view of components of a head-mounted display (HMD) system in accordance with some embodiments.

FIG. 2 illustrates a cross-sectional side view of the HMD system in accordance with some embodiments.

FIGS. 3A and 3B illustrate back views of the HMD system in accordance with some embodiments.

FIG. 4 illustrates a perspective view of the HMD system assembled from the components illustrated in FIG. 1 in accordance with some embodiments.

FIG. 5 is an exploded perspective view illustrating a headset of the HMD system in accordance with some embodiments.

FIG. 6 is an exploded perspective view of a display of the headset in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known systems, methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first segment could be termed a second segment, and, similarly, a second segment could be termed a first segment, without departing from the scope of the various described embodiments. The first segment and the second segment are both segments, but they are not the same segment.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Head-mounted display (HMD) systems are typically made to closely fit across a user's face in order to prevent external light from entering the display and obscuring an image viewed by a user. However, the portion of the HMD system that curves to accommodate the nose tends to allow light to leak in due to an aperture in the nostrils area that allows free air circulation during normal breathing. Also, a problem occurs in that when the user is immersed in a virtual reality experience which requires physical activity or exertion, such as dancing, jumping, swinging, punching, etc., the user's body temperature is elevated, the user starts to perspire, and lenses of the display start to fog up as a result of the elevated temperatures in the space between the user's face and the display. Typical HMD systems present the problem of insufficient ventilation to lenses of the display or to portions of the user's face covered by the HMD, due to efforts to maximize the light-tightness (exclusion of light) of the HMD system.

Accordingly, the present disclosure describes head-mounted display (HMD) systems capable of restricting external light from entering the display and at the same time capable of providing ventilation of the user's face and adjacently positioned lenses of the display, so as to prevent fogging of the lenses and to cool the user's face.

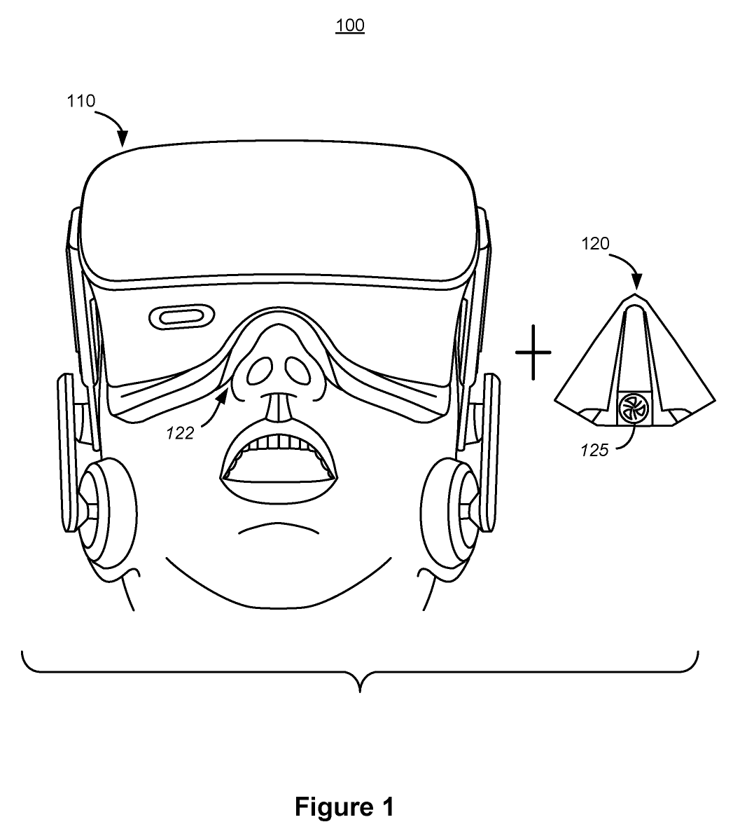

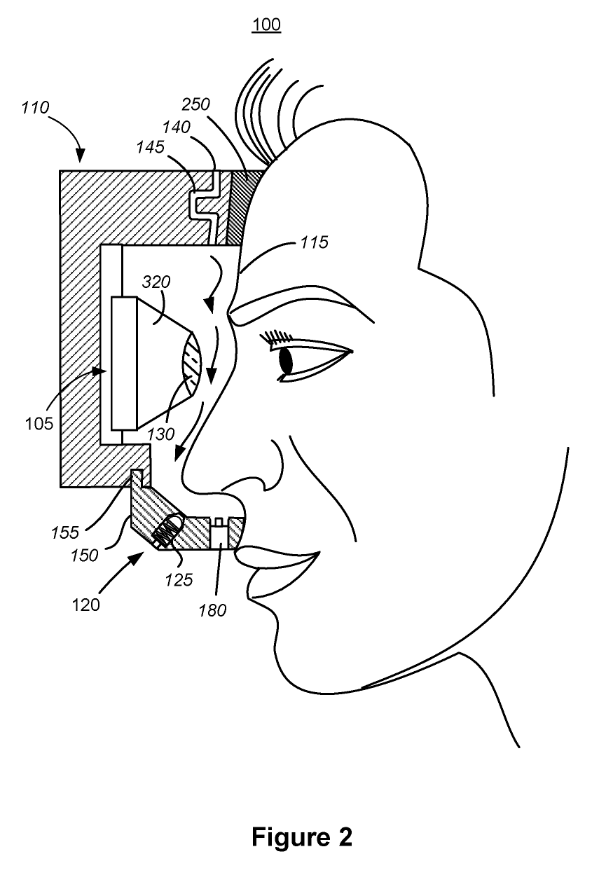

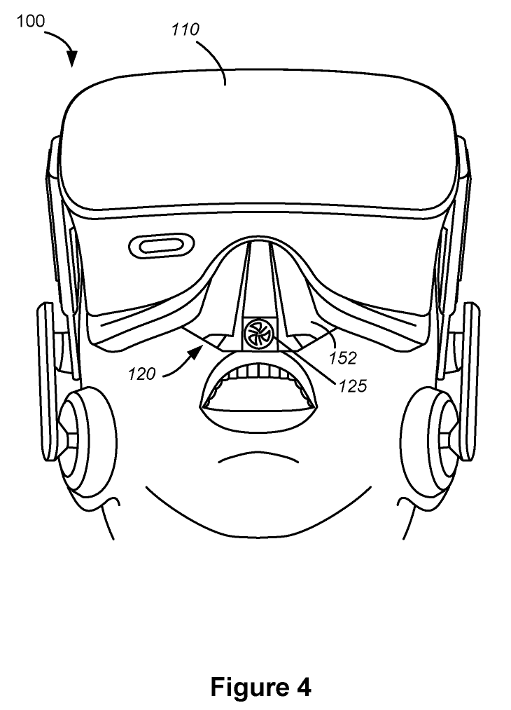

FIGS. 1, 2, 3A, 3B, and 4 illustrate a head-mounted display (HMD) system 100 in accordance with some embodiments. FIG. 1 illustrates a perspective view of components of the HMD system 100, while FIG. 2 illustrates a cross-sectional side view of the HMD system 100, and FIG. 4 illustrates a perspective view of the HMD system assembled from the components illustrated in FIG. 1. As shown in FIG. 1, the HMD system 100 generally comprises a headset 110 and a nose piece 120 coupled to the headset 110, the nose piece 120 including a check valve 125 to allow a uni-directional out-flow of air through the check valve 125 from inside the nose piece 120 while preventing in-flow of air into the nose piece 120 through the check valve 125. As shown in FIG. 2, the headset 110 is configured to be mounted to a user's face 115 and contains a display 105.

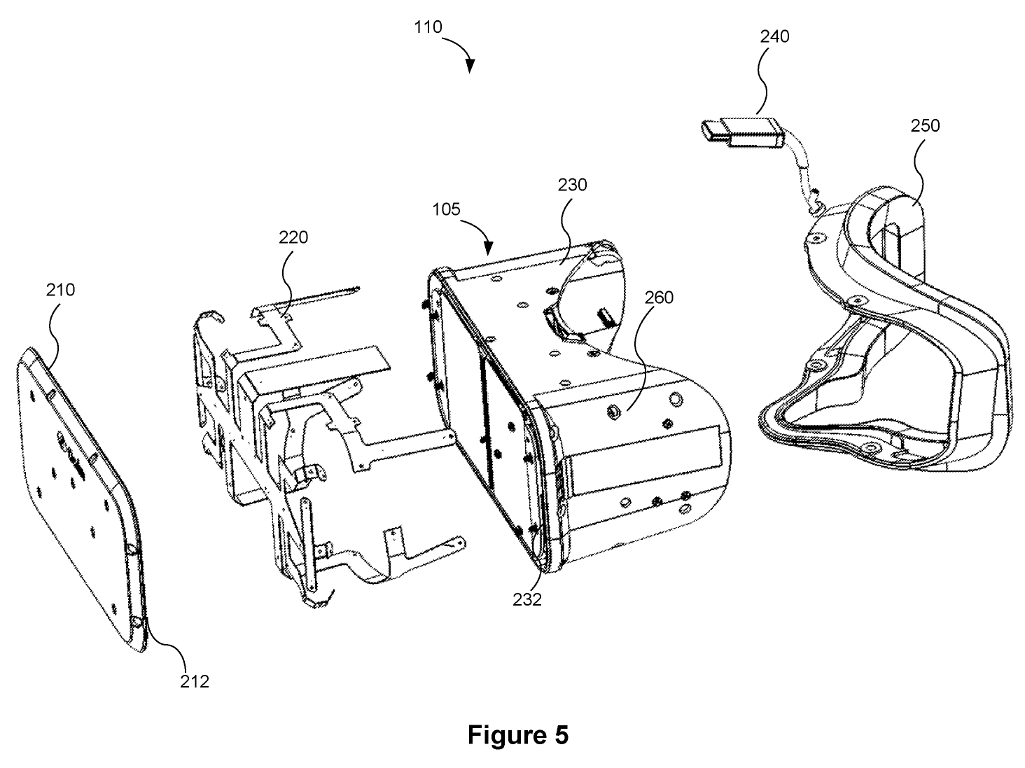

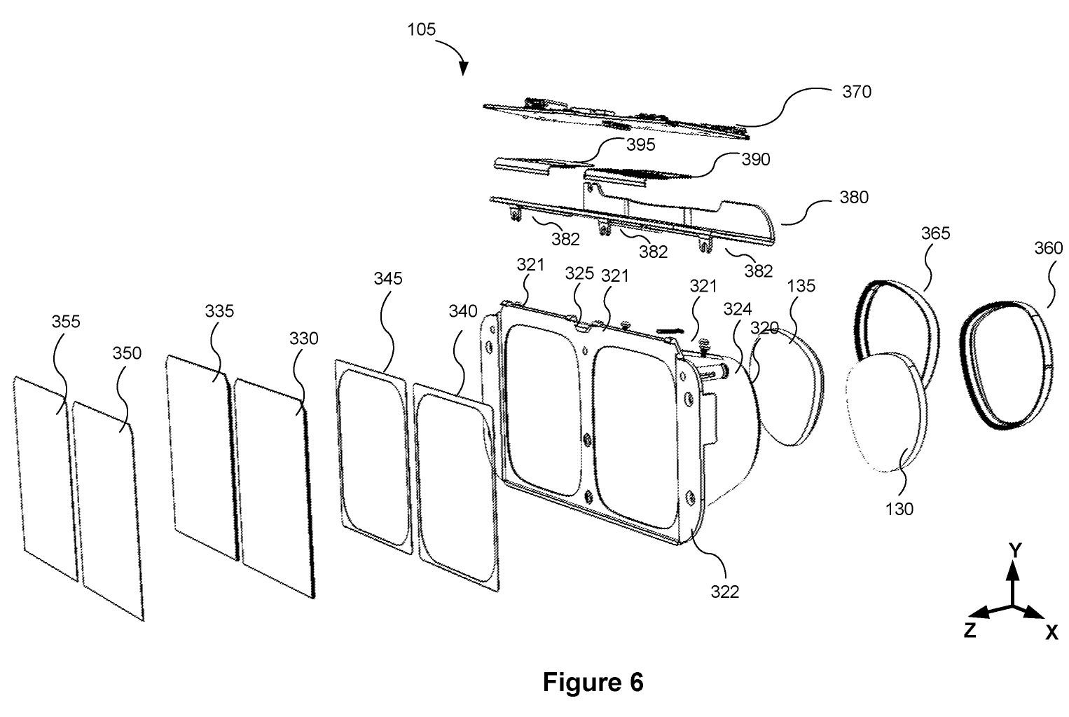

The display 105 includes a left lens 130 for the user's left eye and a right lens 135 for the user's right eye. While examples of features are illustrated in FIG. 2 to show the components of the display 105 for one eye (e.g., the left eye) of the user, the components of the display 105 for the other eye (e.g., the right eye) may substantially mirror (e.g., to within manufacturing tolerances) the structures illustrated in FIG. 2 (e.g., as illustrated in FIGS. 5 and 6). The components for the other eye have not been illustrated in FIG. 2 so as not to obscure pertinent aspects of the embodiments disclosed herein.

In some embodiments, the HMD system 100 further comprises a plurality of apertures 140 positioned above the left and right lenses (e.g. lens 130) to introduce air and provide ventilation to the lenses 130, 135 and the user's face 115.

In some embodiments, the plurality of apertures 140 is positioned on an upper portion of the headset 110. Each aperture 140 of the plurality of apertures comprises an S-shaped duct 145 to channel air into an area between the display 105 and the user's face 115 when the user breathes in. Due to the curvature of the headset 110 forming the S-shaped ducts 145, light is restricted or prevented from entering the HMD system 100 as the light is blocked by portions of the headset 110 which define boundaries of the S-shaped ducts 145. According to the aforementioned configuration, ventilation of the HMD system 100 is achieved while restricting or blocking light from entering into the display 105 through the plurality of apertures 140 in the headset 110.

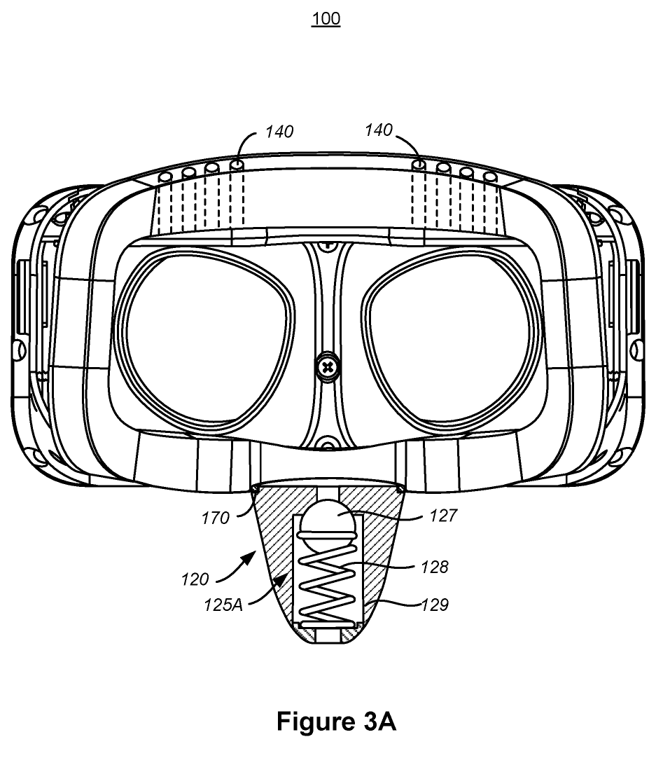

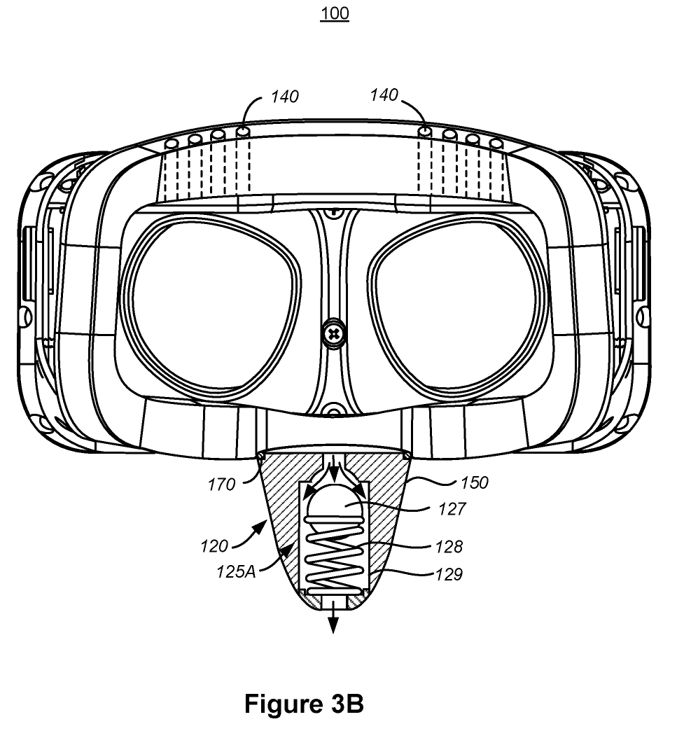

FIGS. 3A and 3B illustrate back views of the HMD system 100 in accordance with some embodiments. FIG. 3A illustrates a configuration in which the check valve 125 of the nose piece 120 is in a closed position, while FIG. 3B illustrates a configuration in which the check valve 125 of the nose piece 120 is in an open position. In some embodiments, the nose piece 120 is configured with the check valve 125 such that when the user inhales during breathing, the check valve 125 remains in the closed position, thereby restricting or blocking air from entering into the HMD system 100 through the check valve 125 and thus the nose piece 120. As a result, when the user inhales, air entering into the user's lungs is drawn into the HMD system 100 from outside the HMD system 100 through the apertures 140. A pressure differential between air inside the HMD system 100 and air outside of the HMD system 100 when the user inhales provides suction force for the air to be drawn into the inside of the HMD through the apertures 140 and to flow into an area between the left and right lenses 130 and 135 and the user's face 115, as illustrated by the arrows in FIG. 2. The aforementioned configuration allows for cooling of the user's face, which may have begun to perspire as a result of the elevated body temperatures caused by active engagement in the virtual reality or gaming experience, and also allows for ventilating of the lenses 130, 135, to prevent fogging or clear fogging which may have occurred as a result of the elevated temperatures within the HMD system 100.

The aforementioned configuration of the HMD system 100 with the nose piece 120 covering the user's nose solves a problem where a significant amount of light leakage into the HMD otherwise occurs through a nose opening at the bottom of the HMD. Because the nose piece 120 covers the nose opening 122 at the bottom of the HMD, light is restricted or blocked from entering through the bottom of the nose piece 120. Although air is blocked or restricted from entering through the nose piece 120 during inhaling, the user is still able to breathe normally and receive ventilation from the air entering through the apertures 140 on the upper portion of the headset 110 as described above. The user exhales through the check valve 125, which opens during exhalation (e.g., as shown in FIG. 3B).

As mentioned above, each aperture 140 comprises an S-shaped duct to channel air into an area between the display 105 and the user's face 115 when the user breathes in. The S-shape of each of the ducts 145 further serves to restrict or block light from entering or leaking into the HMD system 100 through the apertures, thereby enhancing the light-tightness of the HMD system 100. By virtue of the S-shape, light is not able to penetrate to the inside of the HMD system 100 and interfere with images viewed by the user. Thus, external light is restricted or blocked from leaking into the HMD system 100, thereby preventing reflections from being created in the display viewing optics as well as preventing degradation of visual stimuli created by the HMD system 100.

In some embodiments, the nose piece 120 comprises an opaque plastic material. The opaque plastic material may include Polyaryletheretherketone, which is a rigid plastic material and provides an advantage of a strength and robustness. Alternatively, the opaque plastic material may include Polyphenylene Sulphide, which is a heat resistant material and provides an advantage of being able to withstand elevated temperatures. The opaque plastic material may further include plastic polymers such as Polypropylene, High Density Polyethylene, or synthetic Polyvinyl chloride, but is not limited to the aforementioned materials. The nose piece 120 may also include a plastic material which is coated or painted to provide opaque properties. The opaque material provides the advantage of further improving the ability of the nose piece 120 to restrict or block light from entering the HMD system 100 and interfering with the display viewing optics.

In some embodiments, the nose piece 120 comprises a rubber material. The rubber material may include but not be limited to Neoprene (polychloroprene) rubber which exhibits advantages of good chemical stability and maintaining flexibility over a wide temperature range. The rubber material may also include, but is not limited to Acrylonitrile-butadiene rubber, Hydrogenated Acrylonitrile-butadiene rubber, Ethylene-propylene rubber, Polyacrylate rubber, Ethylene-acrylic rubber, Styrene-Butadiene rubber, Millable polyurethane rubber, silicone rubber, Fluorosilicone rubber, and natural rubber. The nose 120 may additionally include, but is not limited to a combination or a composite of any of the aforementioned materials.

In some embodiments, the nose piece 120 comprises a rigid foam material. The foam may be an engineered foam using rigid foam materials, including but not limited to rigid Urethane Foam, Polyisocyanurate Rigid Foam, Polyurethane Foam, Polyethylene Foam, Polypropylene Foam, Expanded Polypropylene Foam, Expanded Polystyrene Foam, Close Cell Foam, and Biodegradable Foam. The nose piece 120 may include, but is not limited to a combination or a composite of any of the aforementioned materials.

FIG. 4 illustrates a perspective view of the HMD system assembled from the components illustrated in FIG. 1 in accordance with some embodiments. In some embodiments, an outer periphery 150 of the nose piece 120 is contoured to accommodate a range of noses while restricting light from leaking into the headset 110. The nose piece 120 is generally defined by a curved or angled surface 152, the outer periphery of which is shaped to follow contours of the user's face. The shape of the outer periphery 150 may be defined or characterized by any suitable characteristic length, angle, curvature or other dimension typical of a nose. The curved or angled surface 152 of the nose piece 120 may be formed (e.g., by machining) into a triangular prism shape, a rounded shape or any shape generally conforming to an outline of a wide range of user's noses. The nose piece 120 may generally protrude outwards from the user's face (so as to accommodate a wide range of lengths and heights, and may generally extend horizontally across a user's face to accommodate a wider range of nose width based on a range of dimensions typical of user's noses.

In some embodiments, the nose piece may be formed of a material which may be manipulated within a pre-defined tolerance range so as to allow a user to press on the curved surface of the nose piece 120 to increase width of the nose piece 120 or allow the user to push on sides of the curved surface of the nose piece 102 to increase a height (protrusion) of the nose piece 120 to suit a wide range of desired nose sizes.

In some embodiments, the nose piece 120 is integrally formed with the headset 110. In these embodiments, the headset 110 and the nose piece 120 form one continuous part so as to reduce a possibility of light leaking through any crevices between connection points of the nose piece 120 and the headset 110. In other embodiments, the nose piece 120 is detachably coupled to the headset and comprises at least one connector 170 to couple to the headset 110. In some embodiments another connector is provided at a corresponding position on the headset 110 to couple to the connector 170 on the nose piece 120. The nose piece 120 may include flanges 155 (as illustrated in FIG. 2) on an outer periphery 150 thereof for coupling to the headset 110 to minimize any leakage of light into the HMD system 100.

In some embodiments, the connector 170 is permanently coupled to at least one of the nose piece 120 and the headset 110. For example, a first connector 170 may be glued to the nose piece 120 and a second connector 170 may be glued to the headset 100 at a position corresponding to the first connector 170 so as to couple the nose piece 120 and the headset 110 to each other. Alternatively, each connector 170 may be sewn, stapled, or mechanically fused (e.g. ultrasonically welded or melted) to the nose piece 120 and/or the headset 110. In other embodiments, each connector 170 is detachably coupled to the nose piece 120 and/or the headset 110.

In some embodiments, each connector 170 comprises a magnet to magnetically couple the nose piece 120 and the headset 110 to each other.

In some embodiments the first connector 170 comprises a hook surface of a hook-and-loop fastener on one of the nose piece 120 and the headset 110, and the second connector comprises a loop surface of the hook-and-loop fastener on the other of the nose piece 120 and the headset 110. The hooks are configured to hook and engage the loops thereby coupling the nose piece 120 and the headset 110.

In some embodiments the first connector 170 comprises a first disc on one of the nose piece 120 and the headset 110 and the second connector 170 comprises a second disc on the other of the nose piece 120 and the headset 110. The first disc has a protrusion protruding from one of the nose piece 120 and the headset 110. The second disc has a groove at a position on the other of the nose piece 120 and the headset 110 corresponding to a position of the protrusion on the first disc. The nose piece 120 and the headset 110 are detachably coupled by insertion of the protrusion into the groove. In yet other embodiments, the connector 170 comprises a snap fastener.

In some embodiments, as illustrated in FIG. 2, the check valve 125 of the nose piece 120 is positioned below nostrils of the user when the headset 110 is mounted on the user's face 115, to selectively allow the out-flow of the air from inside the nose piece 120 through the check valve 125 while preventing air outside of the nose piece 120 from entering in through the check valve 125 and thus the nose piece 120. When the headset 110 with nose piece 120 is worn by the user, and the user exhales, pressure of the air exiting the user's nose (illustrated by the arrows in FIG. 3B) causes the check valve 125 to be pushed to an open position, thus allowing the air to freely exit the nose piece 120. When the user inhales, air pressure causes the check valve 125 to return to an original position towards the user's nose (i.e., the closed position) thereby blocking air from entering the HMD system 100 through the nose piece 120. Thus, the nose piece 120 provides the advantage of sealing off or covering a nose area of the headset 110, thereby preventing light from entering into the HMD system 100 and interfering with viewing optics, while still maintaining ventilation of an inside of the HMD system 100 through the apertures 140 when the user inhales and through the check valve 125 when the user exhales.

As illustrated in FIGS. 3A and 3B, the nose piece 120 includes the check valve 125 positioned in the nose piece 120 so as to be in a direct path of air exhaled out of the user's nose. The check valve 125 is positioned in the nose piece 120 under a nose area of the user to allow the check valve 125 to be sensitive to pressure changes as a result of air exhaled out of and inhaled into the user's nose. The check valve 125 is configured so as to be sensitive to and displaceable by small pressures consistent with air pressures generated during inhaling and exhaling.

In some embodiments, the check valve 125 is selected from the group consisting of a ball check valve, a lift check valve, a wafer check valve, and a flap check valve. In some embodiments, the check valve 125 is spring-loaded to keep the check valve 125 in the closed position illustrated in FIG. 3A.

FIGS. 3A and 3B illustrate a back view of the headset 110 with nose piece 120 and check valve 125 which is a spring-loaded ball check valve 125A in accordance with some embodiments. The check valve 125A uses a ball 127 coupled to a spring 128 inside the valve body 129 to control movement of air flowing into and out of the nose piece 120, as illustrated by the arrows. When the user exhales, pressure of air flowing out of the user's nose displaces the ball 127 in the direction of the air flow (i.e., towards outside of the nose piece) as illustrated in FIG. 3B. As the ball 127 is displaced, the ball 127 pushes against and compresses the spring 128, thereby opening the valve 125A and allowing air to flow out of the nose piece 120 in the direction indicted by the arrows in FIG. 3B. When the user stops exhaling, and begins inhaling, release of the air pressure on the ball 127 causes the spring 128 to expand back towards its original (e.g., uncompressed or less compressed) state, thereby lifting the ball 127 back up to close an opening in the valve body 129 of the valve 125A, as illustrated in FIG. 3A. Thus, when the user inhales, air is prevented by the valve 125A from entering into the headset 110 through the nose piece 120. Instead air flow into the headset 110 occurs through the apertures 140, as described above, as a result of the pressure differential created between air on proximal ends (i.e., air outside the HMD system 100) and air on distal ends (i.e., air inside the HMD system) of each of the S-shaped ducts 145. This brings cooler, lower-humidity outside air inside the HMD on every respiration cycle.

In some embodiments, the ball check valve 125A is coupled to the nose piece through threaded welding or socket welding. The ball 127 may be made of a hard plastic or a rubber material or may be coated with a rubber material to enhance the air tightness sealing of the valve. The spring may be made of any material capable of elastically deforming at low pressures as observed during normal exhaling.

In some embodiments, the check valve 125 may be a lift check valve functioning similarly to the ball check valve 125A described above, but in place of the ball 127, the lift check valve includes a disc (not shown) coupled to a spring, similar to spring 128. In these embodiments, the disc check valve is opened by pressure of the air exiting the user's nose during an exhale causing the disc to move with compression of the spring. The disc check valve is closed by expansion of the spring back towards the original position, thereby causing the disc to rest against the valve body 129 and close an air path into the HMD system 100.

In some embodiments, the check valve 125 may be a wafer check valve formed of rubber material. The wafer check valve may be hingedly connected and spring loaded to the valve body 129. The wafer check valve may be disposed in a recessed opening of the valve body 129 under the nose area of the user to allow the wafer check valve to be sensitive to pressure changes as a result of air exhaled out of and inhaled into the user's nose. During exhalation, the wafer check valve may be hingedly opened by pressure of the air exiting the user's nose along with compression of the spring. The wafer check valve may be closed by expansion of the spring back towards the original position, thereby hingedly closing the wafer check valve against the valve body 129 and closing the air path into the HMD system 100.

In some embodiments, the check valve 125 may be a flap check valve formed of an elastic rubber material. The elastic rubber flap check valve may be a concavely shaped thin flexible rubber material. The flap check valve may be secured to the nose piece 120 by a strap which extends across a central horizontal axis of the flap check valve between along the opening of the nose piece 120 and is secured at opposite ends of the opening spanned by the flap check valve. The flap check valve may be opened by pressure of the air exiting the user's nose during the exhale causing ends of the flap valve to deflect and be arched outwards to allow air out when the user exhales. When the user inhales, the flexible flap check valve returns to its concavely-oriented closed position across the opening, thereby closing the air path into the HMD system 100.

In some embodiments, as illustrated in FIG. 2, the nose piece 120 further includes a smell injector 180 to dispense odorants to be inhaled by the user to stimulate olfactory senses. The smell injector 180 generally contains a battery of micro-containers with scented substances which can release odorants to be inhaled by the user. In some embodiments, the injector 180 is to provide an enhanced virtual-reality experience, for example, when immersed in a virtual reality experience where the user is running through a forest during combat, the injector 180 may dispense a mist of fluid with a scent of trees, leaves or fresh grass, or when immersed in a virtual reality or gaming experience with burning buildings and smoke, the injector 180 may dispense a mist of fluid with a scent of smoke to enhance the virtual reality experience.

FIG. 5 is an exploded perspective view illustrating a headset 110 of the HMD system 100 in accordance with some embodiments. FIG. 5 does not show the nose piece 120. As shown in FIG. 5, the headset 110 includes a surface 250 contoured to accommodate facial features of the user. For example, the surface 250 may be rounded following the contour of the user's face, e.g., a forehead area of a user's face. In some embodiments, the surface 250 comprises a porous material to absorb perspiration of the user. As described above, when the user gets immersed in a virtual reality experience which requires some physical activity, the user may begin to perspire. When the user perspires, the porous surface absorbs sweat collecting on the user's face, thereby preventing sweat droplets from collecting inside the headset 110, dripping onto the lenses 130, 135 and obscuring the viewing optics. In some embodiments, the surface 250 comprises a material selected from the group consisting of an opaque plastic, rubber, rigid foam and neoprene.

In some embodiments, the rigid foam may be an engineered foam using rigid foam materials, including but not limited to rigid Urethane Foam, Polyisocyanurate Rigid Foam, Polyurethane Foam, Polyethylene Foam, Polypropylene Foam, Expanded Polypropylene Foam, Expanded Polystyrene Foam, Close Cell Foam, and Biodegradable Foam. The surface 250 may include, but is not limited to a combination or a composite of any of the aforementioned materials.

In some embodiments, the opaque plastic material may include Polyaryletheretherketone, which is a rigid plastic material and provides an advantage of a strength and robustness. Alternatively, the opaque plastic material may include Polyphenylene Sulphide, which is a heat resistant material and provides an advantage of being able to withstand elevated temperatures. The opaque plastic material may further include plastic polymers such as Polypropylene, High Density Polyethylene, or synthetic Polyvinyl chloride, but is not limited to the aforementioned materials. The surface 250 may also include a plastic material which is coated or painted to provide opaque properties. The opaque material provides the advantage of further improving the ability of the surface 250 to restrict or block light from entering the HMD system 100 and distorting the display viewing optics.

In some embodiments, the surface 250 comprises a rubber material. The rubber material may include but not be limited to Neoprene (polychloroprene) rubber which exhibits advantages of good chemical stability and maintaining flexibility over a wide temperature range. The rubber material may also include, but is not limited to Acrylonitrile-butadiene rubber, Hydrogenated Acrylonitrile-butadiene rubber, Ethylene-propylene rubber, Polyacrylate rubber, Ethylene-acrylic rubber, Styrene-Butadiene rubber, millable polyurethane rubber, silicone rubber, Fluorosilicone rubber, and natural rubber. The surface 250 may additionally include, but is not limited to a combination or a composite of any of the aforementioned materials.

In some embodiments, the headset 110 comprises an opaque front cover 210 to cover the front of the headset 110, flexible circuits 220 distributed inside the headset 110, an opaque housing 230 to house the display 105, the surface 250 coupled to the opaque housing 230 to rest against the user's face when the user wears the headset 110, and electrical connectors 240 (e.g., cables, circuits, wires). The front cover 210 may be coupled to the display 105 using one or more connectors 232, such as screws, by inserting the connectors 232 through the screw holes 212 on the front cover 210. The front cover 210 and the opaque housing 230, when connected, may be considered a single opaque housing of the headset 110. In some embodiments, the housing 230 is opaque at visible wavelengths but not at infrared wavelengths.

A plurality of infrared (IR) LED lights 260 is distributed on the surfaces of the housing 230 and the front cover 210. In conjunction with an external camera, the IR LED lights 260 are used for sensing motions of the user's head. The flexible circuits 220 provide power management and transmit electrical signals among different components (e.g., display screens, IR LED lights 260, a detachable audio system, and/or the injector 180) of the headset 110.

FIG. 6 is an exploded perspective view of the display 105 of the headset 110 in accordance with some embodiments. As shown in FIG. 6, the display 105 includes the left lens 130 for a user's left eye and a right lens 135 for the user's right eye. The display 105 also includes a left display screen 330 disposed in front of the left lens 130 to provide images to the user's left eye through the left lens 130. Similarly, the display 105 includes a right display screen 335 disposed in front of the right lens 135 to provide images to the user's right eye through the right lens 135. In some embodiments, a lateral distance between the left display screen 330 and the right display screen 335 is adjustable. This lateral distance corresponds to an interpupillary distance, which is thus adjustable. The left display screen 330 and the right display screen 335 can be light-emitting diode displays (LEDs), e-ink displays, plasma display panels (PDPs), liquid crystal displays (LCDs), organic light-emitting diode displays (OLED), or using any other suitable display technologies.

As shown in FIG. 6, a left eye cup 320 includes one end coupled to the left lens 130 and an opposite end coupled to the left display screen 330. Similarly a right eye cup 325 includes one end coupled to the right lens 135 and an opposite end coupled to the right display screen 335. In some embodiments, stretchable fabrics (not shown) are connected to (e.g., stitched around) the left eye cup 320 and the right eye cup 325 such that when the user is using the HMD system 100, components inside the headset 110 are covered to avoid any visual interference or confusion to the user.

Further, as shown in FIG. 6, the display 105 includes a left frame 340 situated between the left eye cup 320 and the left display screen 330, and a right frame 345 situated between the right eye cup 325 and the right display screen 335.

In some embodiments, the display 105 also includes a left panel 350 situated in front of the left display screen 330, and a right panel 355 situated in front of the right display screen 335. The left panel 350 and right panel 355 provide backing for the left and right display screens 330 and 335 and protect the left and right display screens 330 and 335.

In some embodiments, the display 105 includes a left mounting ring 360 to mount the left lens 130 on the left eye cup 320. Similarly, a right mounting ring 365 is used to mount the right lens 135 on the right eye cup 325.

In some embodiments as shown in FIG. 6, the left eye cup 320 and the right eye cup 325 are formed in one continuous piece and further integrated with a front bracket 322. The front bracket 322 includes grooves to fit the left frame 340 and the right frame 345, the left display screen 330 and the right display screen 335, and the left panel 350 and the right panel 355. One or more clips 321 are further used to hold the left frame 340 and the right frame 345, the left display screen 330 and the right display screen 335, and the left panel 350 and the right panel 355 within the grooves of the front bracket 322.

As shown in FIG. 6, the display 105 includes a top bracket 380 with one or more clips 382 to couple to one or more protrusions 324 on the left eye cup 320 and the right eye cup 325. In some embodiments, the bracket 380 is further coupled to the housing 230 (FIG. 5) to fix the display 105 inside the housing 230.

The display 105 also includes a circuit board 370 to provide various functionalities, such as power management, electrical connection, and signal transmission. For example, the circuit board 370 includes driver circuitry for the left display screen 330 and the right display screen 335. The circuit board 370 is connected with the flexible circuit 220 and the cable 240. A left flexible circuit 390 and a right flexible circuit 395 are situated on top of the circuit board 370 to electrically connect the circuit board 370 to the left display screen 330 and the right display screen 335.

One or more connectors (e.g., screws) are used to couple the circuit board 370 and the top bracket 380 together. For example, the one or more connectors insert through one or more screw holes on the circuit board 370 and one or more screw holes on the top bracket 380 to couple the circuit board 370 with the top bracket 380.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A head-mounted display system, comprising:
a display including a left lens for the user's left eye and a right lens for the user's right eye;
a headset, containing the display, to mount on a user's face;
a plurality of apertures positioned on an upper portion of the headset, wherein each aperture of the plurality of apertures comprises an S-shaped duct to channel air into an area between the display and the user's face when the user breathes in, and to block light from entering the headset; and
a nose piece coupled to the headset, the nose piece including a check valve to allow a uni-directional out-flow of air from inside the nose piece.

2. (canceled)

3. The head-mounted display system of claim 1, wherein the display further comprises:
a left display screen and a right display screen;
a left eye cup coupled between the left lens and the left display screen; and
a right eye cup coupled between the right lens and the right display screen.

4. (canceled)

5. The head-mounted display system of claim 1, wherein the nose piece is integrally formed with the headset.

6. The head-mounted display system of claim 1, wherein the nose piece is detachably coupled to the headset and comprises at least one connector to couple to the headset.

7. The head-mounted display system of claim 1, wherein an outer periphery of the nose piece is contoured to accommodate a range of noses while restricting light from leaking into the headset.

8. The head-mounted display system of claim 1, wherein the check valve of the noise piece is positioned below nostrils of the user when the headset is mounted on the user's face, to selectively allow the out-flow of the air from inside the nose piece while preventing air outside of the nose piece from entering in through the nose piece.

9. The head-mounted display system of claim 1, wherein the check valve is selected from the group consisting of a ball check valve, a lift check valve, a wafer check valve, and a flap check valve.

10. The head-mounted display system of claim 1, wherein the check valve is spring-loaded to keep the check valve in a closed position.

11. The head-mounted display system of claim 1, wherein the nose piece comprises an opaque plastic material.

12. The head-mounted display system of claim 1, wherein the nose piece comprises a rubber or neoprene material.

13. The head-mounted display system of claim 1, wherein the nose piece comprises a rigid foam material.

14. The head-mounted display system of claim 1, wherein the nose piece further includes a smell injector to dispense a fluid to be inhaled by the user to stimulate olfactory senses.

15. The head-mounted display system of claim 1, wherein the headset comprises a surface contoured to accommodate facial features of the user.

16. The head-mounted display system of claim 15, wherein the surface comprises a porous foam material to absorb perspiration of the user.

17. The head-mounted display system of claim 15, wherein the surface comprises a material selected from the group consisting of an opaque plastic, rubber, rigid foam and neoprene.

18. A head-mounted display system, comprising:
a display including a left lens for the user's left eye and a right lens for the user's right eye;
a headset, containing the display, to mount on a user's face;
a plurality of apertures positioned on an upper portion of the headset, wherein each aperture of the plurality of apertures comprises an S-shaped duct to channel air into an area between the display and the user's face when the user breathes in, and to block light from entering the headset; and
a nose piece integrally formed with the headset, the nose piece including a check valve housed therein to allow a uni-directional out-flow of air from inside the nose piece,
wherein the check valve is positioned below nostrils of the user when the headset is mounted on the user's face, to selectively allow the out-flow of the air from inside the nose piece while preventing air outside of the nose piece from entering in through the nose piece.

19. The head-mounted display system of claim 18, wherein an outer periphery of the nose piece is contoured to accommodate a range of noses while restricting light from leaking into the headset.

20. The head-mounted display system of claim 18, wherein the plurality of apertures is positioned above the left and right lenses.
